(19) United States
(12) Patent Application Publication
(10) Pub. No.: US 2015/0005379 A1
(43) Pub. Date: Jan. 1, 2015

(54) WASTEWATER TREATMENT METHOD

(71) Applicant: PeroxyChem LLC, Philadelphia, PA (US)

(72) Inventors: Philip BLOCK, Garnet Valley, PA (US); Minh TRAN, Los Angeles, CA (US)

(21) Appl. No.: 14/317,634

(22) Filed: Jun. 27, 2014

Related U.S. Application Data
(60) Provisional application No. 61/840,048, filed on Jun. 27, 2013.

(51) Int. Cl. C02F 1/50; A01N 37/16

(52) U.S. Cl. CPC C02F 1/50; A01N 37/16; C02F 2303/04; C02F 2305/00
USPC 514/557

(57) ABSTRACT

The present invention relates to a method for treating wastewater comprising adding a peracid to such wastewater after such wastewater has undergone a filtration step, characterized in that said peracid is added to said wastewater at a first peracid addition point; as well as at one or more subsequent peracid addition point(s) placed at sequential location(s) in a contact chamber. It has been unexpectedly found that such sequential addition is more effective than adding such peracid at a single location.

### CROSS REFERENCE TO RELATED APPLICATIONS

This application claims the benefit of the filing date of U.S. Provisional Application No. 61/840,048, which was filed Jun. 27, 2013. For the purpose of any U.S. application or patent that claims the benefit of U.S. Provisional Application No. 61/840,048, the content of that earlier filed application is hereby incorporated by reference in its entirety.

### FIELD OF THE INVENTION

The present invention relates to a method for treating wastewater comprising adding a peracid to such wastewater after such wastewater has undergone a filtration step, characterized in that said peracid is added to said wastewater at a first peracid addition point; as well as at one or more subsequent peracid addition point(s) placed at sequential location(s) in a contact chamber. It has been unexpectedly found that such sequential addition is more effective than adding such peracid at a single location.

### BACKGROUND OF THE INVENTION

The treatment of wastewater, including household sewage and runoff, typically involves a multistep process to reduce physical, chemical and biological contaminants to acceptable limits before such wastewater can be safely returned to the environment. Among the steps typically employed in a water treatment facility is a disinfection step in which the wastewater is treated to reduce the number of microorganisms present.

This disinfection step may be achieved by a number of different methods, including by treatment with chlorine or chlorinated compounds, ozone, and sulfate-based chemicals. The use of peracids in general, and peracetic acid in particular, to disinfect water has also been proposed in the past. Thus, for example, U.S. Pat. No. 5,736,057 (Minotti) discloses the use of peracids to purify water for human consumption; while WO 2009/130397 (Talasma et al.) discloses the addition of peracetic acid prior to sedimentation and after filtration to purify household water. Somewhat similarly, US Patent Application 2004/0154965 (Baum et al.) proposes the use of peracetic acid to disinfect water in wet and dry weather water disinfection systems.

However, despite such proposals, the use of peracetic acid to disinfect wastewater has not been widely practiced. As is stated by Kekko et al. in WO 2012/028778 (at page 3, lines 6-9): “The use of peracetic acid has not been generalized, despite several publications addressing the purifying effects of peracetic acid, because the metering of peracetic acid is difficult and it is relatively expensive”. Kekko et al. propose to overcome these limitations by adjusting the addition of peracetic acid at a single addition point, based upon the downstream measurement of the redox potential of the treated water.

Accordingly, there is a need for a means of economically disinfecting wastewater using peracids such as peracetic acid such that the advantages of employing such chlorine-free actives can be commercially realized.

### SUMMARY OF THE INVENTION

The present invention relates to a method for treating wastewater comprising adding a peracid to such wastewater after such wastewater has undergone a filtration step, characterized in that said peracid is added to said wastewater at a first peracid addition point; as well as at one or more subsequent peracid addition point(s) placed at sequential location(s) in a contact chamber. It has been unexpectedly found that such sequential addition is more effective than adding such peracid at a single location.

### BRIEF DESCRIPTION OF THE DRAWING

FIG. 1 is a schematic drawing of one embodiment of the present invention.

### DETAILED DESCRIPTION OF THE INVENTION

The treatment of wastewater so that it can be safely returned to the environment typically involves a number of processes to remove physical, chemical and biological contaminants. Although specific treatment plants may use varying processes, in general sewage effluent is first mechanically screened and the flow regulated to remove large objects such as sticks, packaging, cans, glass, sand, stones and the like which could possibly damage or clog the treatment plant if permitted to enter. The screened wastewater is then typically sent through a series of settling tanks where sludge settles to the bottom while grease and oils rise to the surface. After the sludge is removed and the surface materials skimmed off, the wastewater is typically treated with microorganisms to degrade organic contaminants which are present. This biological treatment produces a floc which is typically removed by filtration, either through sand or activated carbon. In the final stages of treatment, the microorganism content of the filtered water is reduced by disinfecting means, often by adding a disinfectant to the wastewater stream before having the mixture pass through a disinfectant contact chamber wherein the disinfectant is maintained in contact with the wastewater for a sufficient period of time to reduce the microorganism level to the desired extent.

In most water treatment plants, chlorine or chlorinated compounds are employed as the disinfectant, with ozone and ultraviolet light treatments also being employed. Although the use of peracids has been proposed, it has yet to gain widespread use due to the low relative cost of bleach and a lack of regulatory drivers regarding trihalomethanes. As is discussed above, the use of complicated metering devices and systems has been proposed in order to reduce operating costs. It has now been unexpectedly found that the sequential addition of a peracid to wastewater at multiple locations after filtration is more effective than adding equal an amount of such peracid at a single location.

Accordingly, the present invention relates to a method for treating wastewater comprising adding a peracid to such wastewater after such wastewater has undergone a filtration step, characterized in that said peracid is added to said wastewater at (a) a first peracid addition point; and (b) at one or more additional peracid addition point or points located at a sequential location or locations in a contact chamber. The method of this invention is useful for a wide variety of wastewater treatment applications including surface discharge, reuse and combined sewer overflow uses.

The preferred peracid for use in the method of the present invention is peracetic acid (peroxyacetic acid or PAA). Peracetic acid is typically employed in the form of an aqueous equilibrium mixture of acetic acid, hydrogen peroxide and peracetic acid. The weight ratios of these components may vary greatly, depending upon the particular grade of PAA employed. Among the grades of PAA which may be employed are those having typical weight ratios of PAA:hydrogen peroxide:acetic acid of from 12-18:21-24:5-20; 15:10:36; 5:23:10; and 35:10:15.

Other organic peracids (also called peroxyacids) suitable for use in the method of this invention include one or more C₁ to C₁₂ peroxycarboxylic acids selected from the group consisting of monocarboxylic peracids and dicarboxylic peracids, used either individually or in combinations of two, three or more peracids. The peroxycarboxylic acid is preferably a C₂ to C₅ peroxycarboxylic acid selected from the group consisting of monocarboxylic peracids and dicarboxylic peracids. The peracid should be at least partially water-soluble or water-miscible.

One preferred category of suitable organic peracids includes peracids of a lower organic aliphatic monocarboxylic acid having 1-5 carbon atoms, such as formic acid, acetic acid (ethanoic acid), propionic acid (propanoic acid), butyric acid (butanoic acid), iso-butyric acid (2-methyl-propanoic acid), valeric acid (pentanoic acid), 2-methyl-butanoic acid, iso-valeric acid (3-methyl-butanoic) and 2,2-dimethyl-propanoic acid. Organic aliphatic peracids having 2 or 3 carbon atoms, e.g., peracetic acid and peroxypropanoic acid, are preferred.

Another category of suitable lower organic peracids includes peracids of a dicarboxylic acid having 2-5 carbon atoms, such as oxalic acid (ethanedioic acid), malonic acid (propanedioic acid), succinic acid (butanedioic acid), maleic acid (cis-butenedioic acid) and glutaric acid (pentanedioic acid).

Peracids having between 6-12 carbon atoms that may be used in the method of this invention include peracids of monocarboxylic aliphatic acids such as caproic acid (hexanoic acid), enanthic acid (heptanoic acid), caprylic acid (octanoic acid), pelargonic acid (nonanoic acid), capric acid (decanoic acid) and lauric acid (dodecanoic acid), as well as peracids of monocarboxylic and dicarboxylic aromatic acids such as benzoic acid, salicylic acid and phthalic acid (benzene-1,2-dicarboxylic acid).

The peracid is added in concentrations sufficient to achieve the desired degree of treatment, which concentrations may be readily determined by one of ordinary skill in the art using routine experimentation. The optimum concentrations will depend upon a number of factors, including the degree and types of microorganisms present; the degree of disinfection or treatment desired; the time in which the wastewater treated remains in the contact chamber; other materials present in the wastewater, and the like.

In general, when the peracid employed is PAA, the total amount of PAA added at all locations should be sufficient to ensure that a concentration of between 0.5 and 50 parts per million by weight (“ppm”) of PAA, preferably of between 1 and 30 ppm of PAA, is present in the wastewater to be treated.

In the practice of the present invention, the first peracid addition point is typically located just before or just after the filtered wastewater enters into the disinfectant contact chamber, preferably within five minutes of such entry. The second and any additional peracid addition point(s) should be sufficiently downstream of the initial addition location to permit enhanced benefits of the present invention to be recognized, but should be sufficiently upstream of the disinfectant chamber discharge point to permit the additionally added peracid to have sufficient contact time with the wastewater to be effective.

In general, it is preferred that the second (and any third or additional) peracid addition point(s) be located at a position such that said addition occurs at least about 10 minutes after the initial addition; and at a position such that such addition occurs at a point at least about 5 minutes, more preferably of at least about 10 minutes, before the wastewater to be treated exits the contact chamber. Thus, for example, when the peracid employed is PAA and the total residence time in the contact chamber is between about 20 and about 120 minutes, it is preferred that the second peracid addition point be located such that the residence time in the contact chamber after such addition is between about 10 and about 110 minutes. However, the optimum addition points for the second (and any subsequent) peracid addition points can be readily determined by one of ordinary skill in the art using routine experimentation.

Where the peracid employed is PAA and two peracid addition points are employed, it is typically preferred that the weight ratio of PAA added at the first addition point to PAA added at the second peracid addition point is between 2:1 and 1:4, more preferably between 1:1 and 1:2. However, the optimum ratios can be readily determined by one of ordinary skill in the art using routine experimentation.

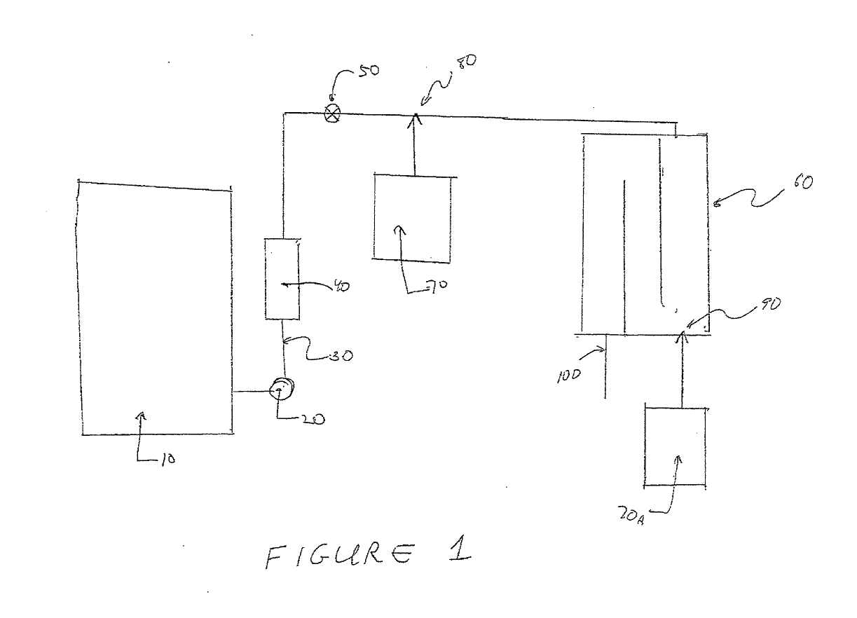

The method of the present invention will be more readily understood by reference to FIG. 1, which presents a schematic drawing of one embodiment of the present invention. Wastewater is drawn from filter 10 employing suction pump 20 into line 30. The flow rate of the water is measured by flow meter 40, and can be adjusted to the rate necessary to effect the desired residence time in contact chamber 60 by adjusting the settings of suction pump 20 and/or ball valve 50 as required.

Peracid, preferably PAA, is added from peracid storage tank 70 at a desired rate to the wastewater prior to its entry into contact chamber 60 at first peracid addition point 80. Although first peracid addition point 80 is shown as being located upstream of contact chamber 60, it is understood that such addition point could be located such that the first addition of peracid is made after the wastewater enters into the contact chamber 60.

After the wastewater has reacted with the peracid added at first peracid addition point 80 for the desired amount of time, additional peracid is added at second peracid addition point 90, located a sufficient location downstream in the contact chamber to permit such first reaction to occur. Peracid is added at the desired rate from peracid storage tank 70A, which may be the same or different tank as peracid storage tank 70. After passing the second peracid addition point 90, the wastewater further reacts with such added peracid for a desired period of time in the contact chamber until it exits such chamber into line 100.

### Examples

Wastewater was diverted post-sand filter treatment at a wastewater treatment plant into a rectangular weir disinfectant contact chamber. The flow rate of wastewater through the contact chamber was set at seven gallons per minute; the average contact time in the contact chamber was 60 minutes.

VigorOx® WWT peracetic acid (FMC Corporation; 15% peracetic acid, 23% hydrogen peroxide by weight) was dosed into the wastewater through Control Corporation lab grade pumps. In Comparative Experiment A, the PAA was introduced just prior to the wastewater's entrance into the contact chamber at a rate of 6.1 ppm. In Example 1, PAA was introduced just prior to the wastewater's entrance into the contact chamber at a rate of 1.5 ppm; and additionally at a point 50 minutes after the wastewater's entry into the contact chamber at a rate of 4.5 ppm. The fecal coliform count of the wastewater was measured at the point the wastewater exited from the contact chamber.

It was found that adding PAA at a sole point just prior to the wastewater's entrance into the contact chamber produced no-detectable readings of coliform bacteria in about 35% of the samples tested. In contrast, the addition of an almost equal amount of PAA at two separate addition points results in no-detectable readings of coliform bacteria in about 50% of the samples tested.

What is claimed is:

1. A method for treating wastewater comprising adding a peracid to such wastewater after such wastewater has undergone a filtration step, characterized in that said peracid is added to said wastewater at (a) a first peracid addition point; and (b) at one or more additional peracid addition point or points located at a sequential location or locations in a contact chamber.

2. The method of claim 1 wherein such wastewater treatment is for surface discharge, reuse or combined sewer overflow use.

3. The method of claim 1 wherein the peracid is peracetic acid.

4. The method of claim 3 wherein the peracetic acid is added at a total rate of between 0.5 ppm and 50 ppm by weight of wastewater.

5. The method of claim 4 wherein the peracetic acid is added at a total rate of between 1 ppm and 30 ppm by weight of wastewater.

6. The method of claim 1 wherein the peracid is added at a first peracid addition point and a second peracid addition point.

7. The method of claim 6 wherein the peracid is peracetic acid.

8. The method of claim 7 wherein the peracetic acid is added at a total rate of between 0.5 ppm and 50 ppm by weight of wastewater.

9. The method of claim 8 wherein the peracetic acid is added at a total rate of between 1 ppm and 30 ppm by weight of wastewater.

10. The method of claim 7 wherein the weight ratio of peracetic acid added at the first peracid addition point to peracetic acid added at the additional peracid addition point is between 2:1 and 1:4.

11. The method of claim 10 wherein the weight ratio of peracetic acid added at the first peracid addition point to peracetic acid added at the additional peracid addition point is between 1:1 and 1:2.

12. The method of claim 1 wherein the first peracid addition point is located at a position such that the peracid is added within five minutes of the wastewater's entry into the contact chamber.

13. The method of claim 1 wherein the one or more additional peracid addition points are located in a position or positions such that the wastewater remains in the contact chamber for at least 5 minutes after peracid is added at such one or more point or points.
